(19) United States
(12) Patent Application Publication
(10) Pub. No.: US 2015/0315966 A1
(43) Pub. Date: Nov. 5, 2015

(54) Hypersonic Vehicle Base Drag Reduction and Improved Inlet Performance Through Venting Forebody Bleed Air to Base Area Using Open Core Ceramic Composites

(71) Applicant: The Boeing Company, Chicago, IL (US)

(72) Inventors: Todd Magee, Huntington Beach, CA (US); Ben Y. Won, Huntington Beach, CA (US)

(73) Assignee: The Boeing Company, Chicago, IL (US)

(21) Appl. No.: 14/267,716

(22) Filed: May 1, 2014

(51) Int. Cl. F02C 7/04

(52) U.S. Cl. CPC F02C 7/04; F05D 2220/80

(57) ABSTRACT

A system and method of air routing for an air-breathing engine is disclosed. Air enters the front of a scramjet engine via an inlet region. The inlet region is connected to a duct, which extends to the aft region of the scramjet engine where a base area of the air-breathing engine is located. The duct walls are formed using a porous structure fluidly coupled to apertures in both the inlet region and the base area. The air that enters the inlet region is routed through the porous walls of the duct and expelled at the base area. This expulsion of air through apertures in the base area causes base pressure to increase, which reduces base drag. Additionally, pulling air through perforations in the inlet region reduces the amount of low momentum flow entering the engine, which improves engine performance.

### GOVERNMENT RIGHTS

This invention was made with Government support under F33615-03-9-2422 awarded by the Department of Defense. The Government has certain rights in this invention.

### FIELD

The disclosure relates to aerodynamic base drag reductions and improved engine inlet performance by venting high pressure boundary layer air at the vehicle's engine inlet, known as the forebody, and ducting it aft to increase base pressure.

### BACKGROUND

As shown in FIG. 6A, a hypersonic vehicle 600 with an air breathing engine 602 typically uses a boost stage 604 to accelerate from low speeds to high speeds to enable the ignition and function of the air breathing engine 602. Scramjet engines typically require air flow greater than Mach 3.0 to enable combustion within the engine by aligning internal shock waves to adequately compress the airflow. It is at the boosted speed that the scramjet begins to produce thrust. Once thrust is produced, the boost stage 604 is jettisoned as shown in FIG. 6B. For example, the hypersonic vehicle 600 may use the boost stage 604 for speeds up to approximately Mach 3.5 to enable engine ignition, and once the engine 602 is running, the boost stage 604 is then discarded to reduce overall weight and drag of the vehicle 600. A scramjet with a running engine that produces more thrust than drag will accelerate to higher speeds.

The tandem configuration of the air breathing vehicle 600 with the scramjet engine 602 and the boost stage 604 functions as a single vehicle until the boost stage 604 is jettisoned. Functioning as a single vehicle requires interconnection of the structural, mechanical, and electrical systems. The interface of the air breathing vehicle 600 to the boost stage 604 requires surface area large enough to join the boost stage 604 to the air breathing vehicle 600, and also join both electrical and mechanical systems of both the boost stage 604 and the air breathing vehicle 600. The interface surface area is defined as the base area of the air breathing vehicle 600. The base area will always be greater than zero due to these interconnected systems and, therefore, a method for alleviating base drag caused by the base area will improve overall air vehicle acceleration.

The base drag is proportional to the base area and base pressure coefficient. The base drag increases as base area increases and reduces when base pressure increases. Venting forebody high pressure air aft increases base pressure, which in turn decreases base drag. Venting the boundary layer locally reduces boundary layer thickness allowing for more air flow mass capture without dimensionally changing the outer mold line. Increased mass flow improves engine thrust with no drag penalties.

### SUMMARY

A system and method for reducing drag and improving inlet performance of air-breathing vehicles is disclosed. A system of air routing for an air breathing engine includes a duct formed by walls comprising a porous material. The system also includes an inlet region including a first plurality of apertures fluidly coupled to interconnected cavities of the porous material. The system also includes a base area region having a base including a second plurality of apertures fluidly coupled to the interconnected cavities of the porous material.

A method of routing air through walls of an air breathing engine for improved performance of an air vehicle powered by the air breathing engine includes passing air through a first plurality of apertures in an inlet region of an air-breathing engine to a plurality of interconnected cavities in a duct wall of the air-breathing engine. The first plurality of apertures is fluidly coupled to the plurality of interconnected cavities. The method also includes routing the air through the interconnected cavities from a front portion towards a rear portion of the duct wall and passing the air through a second plurality of apertures in a rear surface of the air-breathing engine.

An air breathing engine is also described. The air breathing engine includes an engine duct comprising porous walls, an inlet region having apertures for allowing air to flow into porous walls of the engine duct. The air breathing engine also includes an aft region having apertures for allowing the air to flow out of the porous walls of the engine duct.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is an illustration of a side view of a hypersonic air breathing vehicle, according to an example;

FIG. 2 is an illustration of a base of the hypersonic air breathing vehicle depicted in FIG. 1, according to an example;

FIG. 3 is an illustration of a bottom view of the hypersonic air breathing vehicle depicted in FIG. 1, according to an example;

FIG. 4 is an illustration of an inlet lip and inlet ramp depicted in FIG. 3, according to an example; and

FIG. 5 is an illustration of a base depicted in FIG. 3, according to an example.

FIG. 6A is an illustration of a boost stage before it is jettisoned, according to an example. FIG. 6B is an illustration of the boost stage after it is jettisoned, according to an example.

The drawings are for the purpose of illustrating example embodiments, but it is understood that the inventions are not limited to the arrangements and instrumentality shown in the drawings.

### DETAILED DESCRIPTION

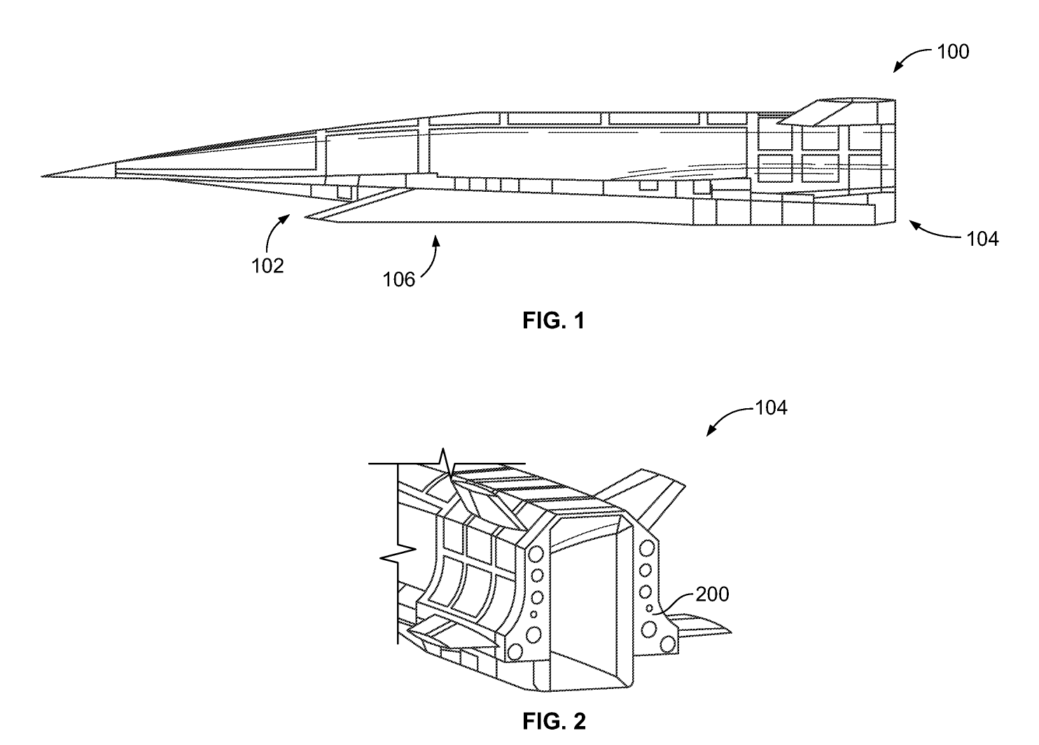

FIG. 1 is a side view of a hypersonic air breathing vehicle 100 after a boost stage has been jettisoned. The vehicle 100 has an inlet region 102 and an aft region 104. As the vehicle 100 moves forward, air enters the inlet region 102 and an air breathing engine 106, such as a scramjet, compresses the air. The air breathing engine 106 burns a gaseous fuel with atmospheric oxygen from the compressed air to produce heat. The air breathing engine 106 then accelerates the heated air to produce thrust as supersonic exhaust exits the aft region 104.

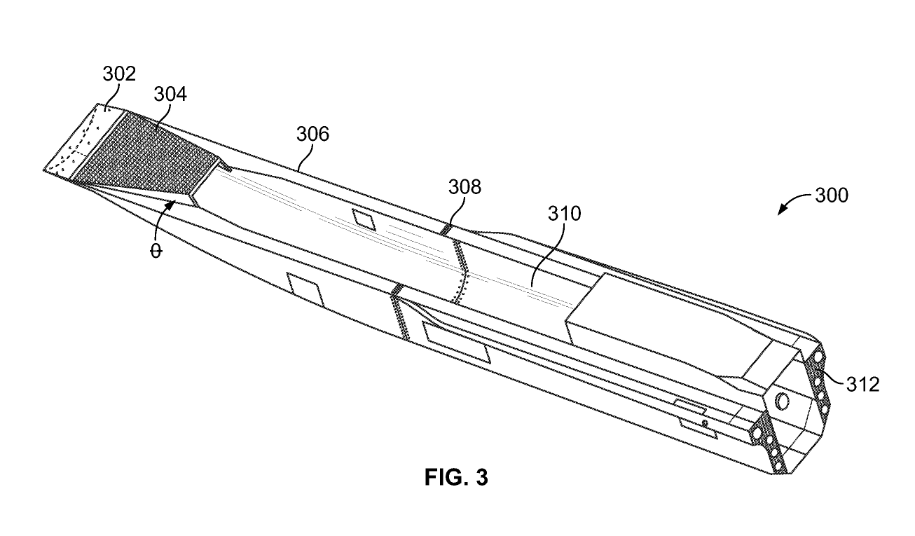

FIG. 2 depicts the aft region 104 of the hypersonic air breathing vehicle 100 depicted in FIG. 1. A base 200 at a backend of the vehicle 100 is used to run mechanical and control systems between the vehicle 100 and the boost stage when it is attached. The base 200 has a flat cross-section area, which creates base drag once the boost stage is jettisoned. The base drag is directly proportional to base area and base pressure. As a result, increasing base pressure reduces base drag.

The performance of the hypersonic air breathing vehicle 100 can also be improved by increasing thrust. For example, thrust can be increased by improving mass capture and inlet performance. One way to increase mass capture and inlet performance is by reducing the boundary layer thickness going into the inlet.

FIG. 3 is a bottom view 300 of the hypersonic air breathing vehicle 100 depicted in FIG. 1. The bottom view 300 shows that the inlet region 102 includes an inlet lip 302 and inlet ramp 304. Duct walls 306 are located between the inlet ramp 304 and a base 312. FIG. 3 also shows a duct 310 where an air breathing engine is located during operation of the hypersonic air breathing vehicle 100.

The inlet lip 302 guides air into the inlet ramp 304 where the air is compressed as it is routed to the duct 310. The inlet ramp 304 is defined by a ramp angle θ relative to freestream flow, which controls how much the air is compressed. For example, the ramp angle θ may be between 5 and 10 degrees. Other ramp angles are possible and depend upon the maximum air speed expected for the hypersonic air breathing vehicle 100. The inlet region 102 and, in particular, the inlet ramp 304 is an area of high pressure during flight.

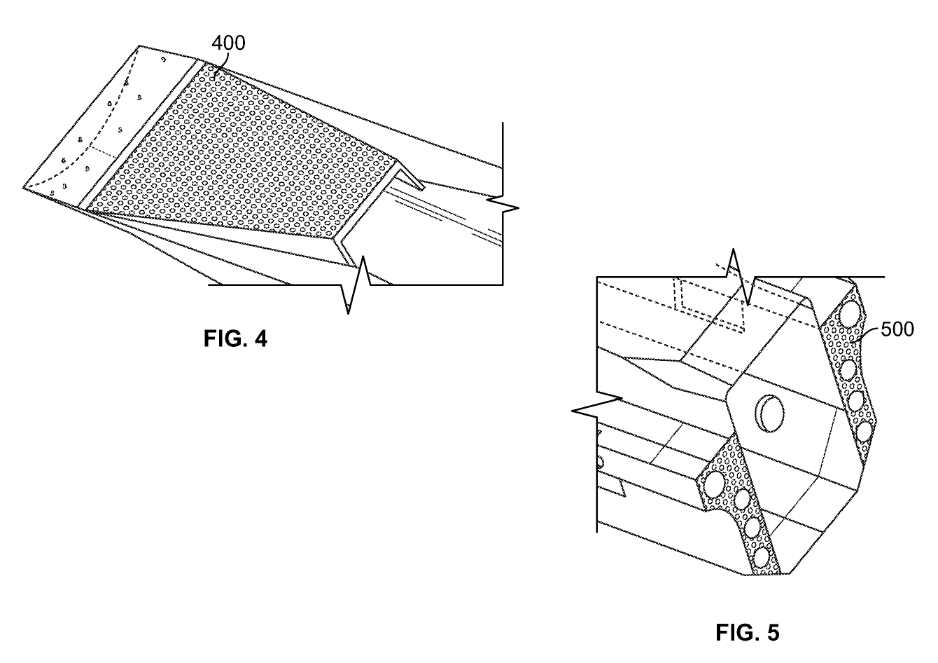

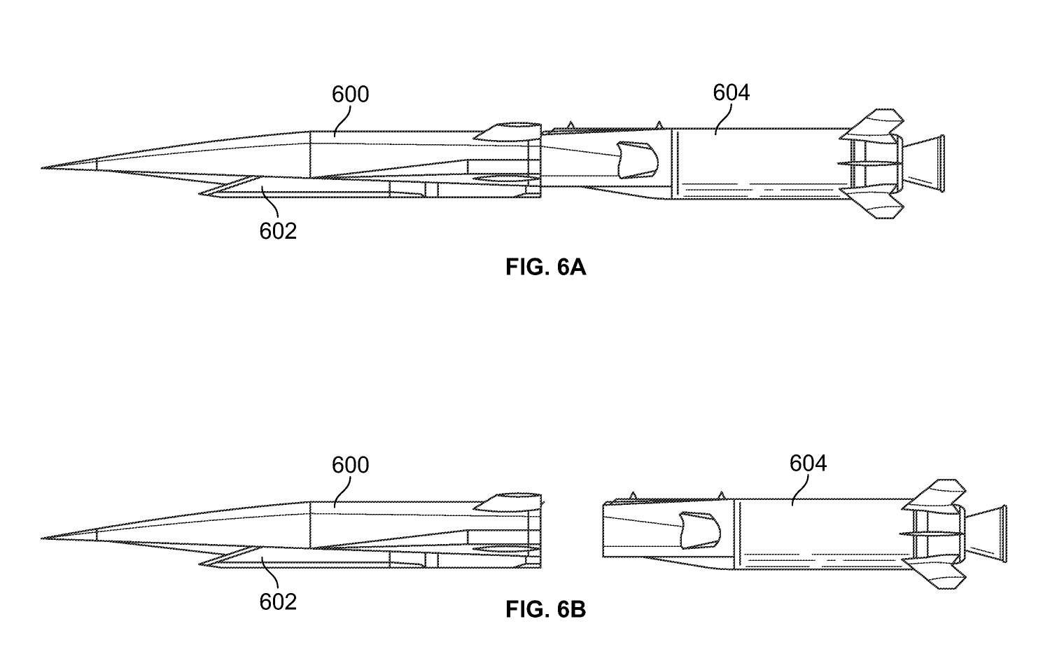

As seen more clearly in FIG. 4, the inlet ramp 304 includes apertures 400. In one example, walls of the inlet ramp 304 are made using a porous material having interconnected cavities or channels, which are fluidly connected to apertures at the inlet ramp 304. The level of porosity depends on each vehicle's outer mold line and expected flight profile. One skilled in the art can determine an optimum level of porosity for a particular vehicle using Computational Fluid Dynamics (CFD) analysis and confirming the analysis with wind tunnel testing. While the range of porosity is relatively low, i.e., 1%-2%, the actual porosity level is optimized for each vehicle configuration and flight profile.

Preferably, the porous material is an open core Ceramic Matrix Composite (CMC) material. CMC material is a reinforced ceramic material created from substantially continuous fibers bound in a ceramic matrix. The fibers can be in tape or cloth form and may include, but are not limited to, fibers formed from silicon carbide, alumina, aluminosilicate, aluminoborosilicate, carbon, silicon nitride, silicon boride, silicon boronitride, and similar materials. The ceramic matrix may include, but is not limited to, matrices formed from aluminosilicate, alumina, silicon carbide, silicon nitride, carbon, and similar materials. In one embodiment, the CMC material is comprised of alumina fibers in an aluminosilicate matrix, i.e., an oxide/oxide CMC. In another embodiment, the CMC material may be comprised of silicon carbide fibers in a silicon carbide matrix, i.e., a SiC/SiC CMC.

The duct walls 306 are also formed using a porous material that allows air to travel through the walls 306 from the inlet ramp 304 to the base 312 of the hypersonic air breathing vehicle 100. For example, the porous material may have a truss formation. As with the walls of the inlet ramp 304, the range of porosity is relatively low, i.e., 1%-2%, and the actual porosity level is optimized for each vehicle configuration and flight profile. Preferably, the duct walls 306 are also composed of an open core CMC material.

The open core CMC material can withstand high temperatures without degradation. For example, the bleed air may be in the range of 1300° F. and 1500° F. As a result, the open core CMC material allows high temperature bleed air to vent from the inlet ramp 304 to the base 312 without any compromise to the strength of the walls 306.

The duct walls 306 allow air to flow from apertures 400 in the inlet ramp 304, through the interconnected cavities of the truss formation of the duct walls 306 to the base 312. The air passively bleeds into a front portion of the duct walls 306, meaning that no additional energy is expended to bleed air into the duct walls 306. The air bleeds into the duct walls 306 due to high pressure region at the inlet region 102 and vacuum pressure at the base 312. As a result, no pump or other machinery is needed for the air bleed to occur.

As seen more clearly in FIG. 5, the base 312 includes apertures 500. The apertures 500 are also fluidly coupled to interconnected cavities of the porous material of the duct walls 306. Like the inlet ramp 304 and the duct walls 306, the base 312 is also preferably made using open core CMC material with a relatively low range of porosity, i.e., 1%-2%.

The open core CMC material allows the high pressure in the inlet region 102 of the vehicle 100 to increase the pressure on the base 312 of the vehicle 100, which reduces the base drag of the vehicle 100. For example, the base drag of the vehicle 100 may be reduced by approximately 20% using open core CMC material.

Additionally, this passive bleed on the inlet region 102 is driven by the base pressure. Passive suction from the base 312 removes or reduces low momentum boundary layer flow from the inlet region 102. Thus, the passive air bleed increases inlet performance. During wind tunnel testing, the passive air bleed improved inlet performance by 1-1.5%, which is significant for the hypersonic air breathing vehicle 100.

The duct 310 may be formed with continuous duct walls 306. Alternatively, as shown in FIG. 3, the duct 310 may be formed using more than one wall section connected at a joint 308. The wall sections may be connected at the joint 308 using one or more fasteners, such as rivets. It is also understood that more than one joint 308 may be used to join wall sections.

Hypersonic air breathing vehicles work on small levels of positive acceleration, so reducing drag and improving inlet performance improves the overall performance of the vehicle. Air vehicle acceleration is measured by subtracting drag from thrust. Venting the forebody reduces the boundary layer thickness, allowing greater mass capture at the engine inlet, thereby improving engine thrust. Base drag is proportional to the base area and base pressure coefficient, thus, increasing base pressure reduces base drag thereby reducing overall vehicle drag.

By using the passive bleed through the open core CMC material of the duct walls 306, the vehicle 100 benefits from both reduced base drag and improved inlet performance. Specifically, ducting high pressure air from the inlet ramp 304 to the base 312: (1) increases pressure on the base 312 of the vehicle 100, which reduces base drag; and (2) reduces the inlet boundary layer, which improves inlet mass capture and, ultimately, engine efficiency. In this manner, the duct walls 306 act as both a plenum and ducting. Thus, with no exterior changes to the vehicle's overall shape, known as the outer mold line, the engine performance is improved yielding higher thrust, and overall aerodynamic drag is reduced by reducing base drag. Beneficially, overall air vehicle acceleration is increased with no outer mold line changes.

While the air breathing engine was described in the context of a scramjet, the use of a porous material in the duct walls 306 is also beneficial to other air breathing engines that have a large base area (e.g., a rear surface area that is not aerodynamically contoured, for example, for the purpose of mating with other components). For example, a ramjet may also benefit from the use of porous materials, such as open core CMC materials.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A system of air routing for an air breathing engine, comprising:
a duct formed by walls comprising a porous material;
an inlet region including a first plurality of apertures fluidly coupled to interconnected cavities of the porous material; and
a base area region having a base including a second plurality of apertures fluidly coupled to the interconnected cavities of the porous material.

2. The system of claim 1, wherein the porous material has a truss formation.

3. The system of claim 1, wherein the porous material is an open core ceramic matrix composite material.

4. The system of claim 3, wherein the open core ceramic matrix composite material is an oxide/oxide ceramic matrix composite material.

5. The system of claim 1, wherein the inlet region includes a ramp positioned at an angle relative to freestream flow to compress air as the air is directed from the inlet region into the duct.

6. The system of claim 5, wherein the ramp has a wall comprising a porous material.

7. The system of claim 6, wherein the porous material of the ramp wall is an open core ceramic matrix composite material.

8. The system of claim 6, wherein at least one of the duct walls and the ramp wall has a porosity level in the range of 1%-2%.

9. The system of claim 1, wherein the base is flat.

10. A multi-stage hypersonic air vehicle comprising:
a first stage; and
a second stage including an air breathing engine and the system of claim 1, wherein the second stage is removably coupled to the first stage at the base abutting a surface of the first stage.

11. A method of routing air through walls of an air breathing engine for improved performance of an air vehicle powered by the air breathing engine, comprising:
passing air through a first plurality of apertures in an inlet region of an air-breathing engine to a plurality of interconnected cavities in a duct wall of the air-breathing engine, the first plurality of apertures fluidly coupled to the plurality of interconnected cavities;
routing the air through the plurality of interconnected cavities from a front portion towards a rear portion of the duct wall; and
passing the air through a second plurality of apertures in a rear surface of the air-breathing engine.

12. The method of claim 11, wherein passing air through the first plurality of apertures includes passively bleeding air into the front portion of the duct wall.

13. The method of claim 12, further comprising reducing the amount of low momentum flow at the inlet region.

14. The method of claim 11, wherein the inlet region includes an inlet ramp comprising an open core ceramic matrix composite material, the passing air through the first plurality of apertures including passively bleeding air into interior cavities of the open core ceramic matrix composite material.

15. The method of claim 11, wherein the duct wall comprises an open core ceramic matrix composite (CMC) material, the interconnected cavities defined by pores of the open-core CMC material.

16. The method of claim 11, wherein the rear surface is flat, the passing the air through the second plurality of apertures in the rear surface including reducing a base drag at the rear surface.

17. An air breathing engine, comprising:
an engine duct comprising porous walls;
an inlet region having apertures for allowing air to flow into the porous walls of the engine duct; and
an aft region having apertures for allowing the air to flow out of the porous walls of the engine duct.

18. The air-breathing engine of claim 17, wherein the air-breathing engine is a scramjet.

19. The air-breathing engine of claim 17, wherein the aft region includes a base area for a boost stage connection.

20. The air-breathing engine of claim 17, wherein the porous walls of the engine duct comprises open core ceramic matrix composite material.
